(19) United States
(12) Patent Application Publication
(10) Pub. No.: US 2014/0241784 A1
(43) Pub. Date: Aug. 28, 2014

(54) INTERACTIVE RETAINING DEVICE

(71) Applicants: Jeff Baker, Orlando, FL (US); Mark Bunker, Orlando, FL (US); Stephanie L. Paulauskas, Orlando, FL (US)

(72) Inventors: Jeff Baker, Orlando, FL (US); Mark Bunker, Orlando, FL (US); Stephanie L. Paulauskas, Orlando, FL (US)

(21) Appl. No.: 13/777,172

(22) Filed: Feb. 26, 2013

(51) Int. Cl. B42F 13/40

(52) U.S. Cl. CPC B42F 13/40
USPC 402/4

(57) ABSTRACT

In one embodiment, a retaining device is provided herein, the retaining device includes a body portion including at least a first planar cover member and a second planar cover member, each of the first and second planar cover members including an outer edge and an inner edge. The first and second planar cover members are associated with one another at each respective inner edge. The retaining device further includes a user interactive component associated with the body, wherein the user interactive component provides an output to a user of the retaining device. In another embodiment, a container having a plurality of walls and an interactive component providing an output to a user is provided. The outputs include sensory outputs such as visual, audio, scent emission and heat.

### BACKGROUND

People are required to manage many pieces of information in the course of a typical day relating to appointments, errands, projects and responsibilities. In addition, a person has goals and other personal matters which need to be incorporated into the planning of one's day in order for them to be realized. Besides the recurring and/or ordinary pieces of information an individual must track and record (which can clutter a person's mind or workplace), it is necessary to make note of new and important ideas lest they be forgotten. In general, having to remember a great many pieces of information tends to make a person feel overwhelmed and therefore, less productive and creative.

Additionally, conveying information to educate or advertise can be accomplished by displays that employ any number of techniques to provide portability and ease of use. Often these displays incorporate eye-catching graphics as part, or all, of the information. Many binders in the art include printed text on the binder material which conveys information to a user.

However, there remains a demand for a binder or retaining device which provides an eye-catching display for a user in order to provide information to and communicate with the user while also providing the benefits of an organization device. As a result, there remains a demand for improvements in the art.

Wire bound or spiral bound notebooks have been on the market for many years. Conventionally, the wire bound notebook includes a pair of separate cover members which include wire receiving holes or perforations along their inner edges and along the inner edges of loose leaf sheets bound into the notebook. The wire is wound helically through the registered perforations of the discrete cover members and those of the pad of paper. Similarly, three-ring binders have been available for years that have a number of binding jaws that open and close to secure loose leaf paper. Both styles of binders require that the document being held must be perforated in order to have the wire or binding jaws engage the document.

U.S. Pat. No. 7,704,006 teaches a ring binder that contains an expandable pocket. Documents may be held in the slits provided in the expandable pocket. The expandable pocket is held in place and restrained by the binder covers and the zip-able skirt.

The inventors have realized a need for an organization device or retaining device which also provides a means for communication with a user or an eye-catching feature associated therewith.

### SUMMARY

In one embodiment, a retaining device is provided. The retaining device includes a body portion including at least a first portion and a second portion, each of the first and second portions including an outer edge and an inner edge. The first and second portions are associated with one another at each respective inner edge. The retaining device further includes a user interactive component associated with the body, wherein the user interactive component provides communication between the device and a user of the retaining device.

In another embodiment, a retaining device including a first planar cover member and a second planar cover member is provided. Each of the first and second planar cover members include an outer surface, an inner surface, an inner edge, an outer edge, a first end edge and a second end edge. A bridge member including a planar bridge body portion having a bridge inner surface, a bridge outer surface, a first bridge outer edge and a second bridge outer edge, is provided wherein the first bridge outer edge associates with the first planar cover member inner edge and the second bridge outer edge associates with the second planar member inner edge. The retaining device further includes a binding mechanism associated with the bridge inner surface, the first planar cover member inner surface, or the second planar cover member inner surface. The binding mechanism includes at least one binding member that moves from a released state to a binding state. The retaining device further includes a visual display component associated therewith.

### BRIEF DESCRIPTION OF THE DRAWINGS

FIG. 1 provides a perspective bottom side view of an embodiment of a retaining device in a closed position.

FIG. 2 provides a perspective bottom side view of an embodiment of a retaining device in an open position.

FIG. 3 provides a perspective bottom view of an embodiment of a retaining device in a closed position.

FIG. 4 provides a perspective view of an embodiment of a retaining device in an open position.

FIG. 5 provides a perspective view of another embodiment of a retaining device in a closed position.

FIG. 6 provides a perspective view of another embodiment of a retaining device in an open position.

FIG. 7 provides a perspective view of another embodiment of a retaining device in a closed position.

FIG. 8 provides a perspective view of another embodiment of a retaining device in an open position.

FIG. 9 provides a perspective view of another embodiment of a retaining device in a closed position.

FIG. 10 provides a perspective view of another embodiment of a retaining device in an open position.

### DETAILED DESCRIPTION

For the purposes of promoting an understanding of the principles and operation of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to those skilled in the art to which the invention pertains.

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

It has been discovered that multi-sensory learning establishes multiple pathways in separate areas in the brain and ultimately results in a highly effective learning experience. However, in order to gain benefits from multi-sensory learning devices, certain requirements must be met including but not limited to the following: the sources of stimuli must be in close proximity to one another; the sources of stimuli must be synchronous; the stimuli must be congruous semantically, otherwise the superior colliculus (area of the brain located in the midbrain known for integrating multiple sources of information) will segregate the stimuli instead of integrate them; and finally, the use of extraneous materials must be limited. With knowledge of the essential factors in multi-sensory learning and incorporation of the multi-sensory learning features into a device, the inventors have developed a novel, cutting-edge retaining device which in some embodiments comprises sensory feedback. Furthermore, the device includes sequential output as will be described in additional detail below.

Aspects of the invention are directed to improved binders and other retaining devices constructed to display and retain materials and to provide information or an eye-catching feature to a user, or educate a user while taking advantage of the effective multi-sensory learning described above.

Advantages of the retaining device include the ability to store and retain documents and other items while presenting information in an educational, informative, and/or entertaining manner or providing an eye-catching feature. Information can be presented by making use of the various senses of the user via the interactive component of a retaining device, in one embodiment. Some of the senses used to present such information include sight, smell, hearing, taste, and touch. For example, LED technology can be used to light one or more aspects of the device as part of the visual display component of the device, in one embodiment. This technology can be used to highlight information that is of particular importance on the device, or may be used purely for eye-catching, entertainment purposes.

The display device may incorporate EPD (electronic paper display) technology to provide information to a user, or may include both EPD and LED such that the device can be used in conditions where varied lighting is available. The device may be lit by any other means known in the art, and the visual display components may be disposed on any portion of the device so long as light provided by the lighting feature may be seen by a user of the display device. Furthermore, the retaining device may include multiple layers or strata upon which the lighting features or visual display features are provided. The term “strata” or “stratum” as used herein includes a layer or series of layers which form the body of the device, each of which are generally superimposed over one another.

The user interactive component may be placed inside the device and activated upon opening of the device, or may be activated via a switch associated with the device. Alternatively, the user interactive component may be placed on an outer portion of the device or on the spine of the device. The device may further feature a magnetic contact switch such that when in a closed position, the lighting feature is off, and when in an open position, the lighting feature is on. The magnetic switch may also be the attachment member 53, in an embodiment. The lighting feature, in one example, may alternatively be placed on an outer surface of the device, for example, on the outer surface of either of the first or second planar cover member or on the bridge member portion of the device. The retaining device may include multiple interactive components. The device may include a battery, a switch, a processor, and LED/EPD. All of the components of the interactive component(s) of the retaining device may be electrically connected as necessary to provide an integrated system.

In another embodiment, the device may include one or more sensors provided to detect a condition of the device. An output to a user of the device may be initiated from the interactive component in response to a predetermined value for a condition. In a particular embodiment, the sensor may be an orientation sensor provided to detect an orientation of the device, where in the interactive component is initiated if the orientation of the device meets a predetermined orientation. In another embodiment, the condition may be movement or lack thereof, of the device, wherein a sensor detects any movement of the device, or any lack of movement, and initiates an output to the user in response. In yet another embodiment, a sensor may detect a contact or an insufficient contact between the device and the user, the device and another object or between one portion and another portion of the device itself and provide an output to the user in response. In one example, the contact detected may be a closing of the device where one portion of the device contacts another portion of the device or an opening of the device where one portion of the device is not in contact with another portion of the device, an output may be initiated. A predetermined contact value used to determine whether a “condition” has occurred may be set at 100% contact between the device and the user, another object, or another portion of the device, or the contact value may be set between 90-99%, or 80-88% contact such that the user can be made aware when there is sufficient contact.

### Definitions:

The term “associated” as used herein includes disposed on, integrated into or integrated with, attached or affixed thereto via either a direct or an indirect connection or in engagement with, e.g., the visual display component is in engagement with the retaining device. Associated may include but is not limited to direct or indirect attachment, adjacent to, in contact with, partially or fully attached to, and/or in close proximity with.

The term “user interactive component” as used herein includes visual display components as well as sound emitting members, scent emitting members and associated heating elements, gustatory members and other somatosensory features of the device. The user interactive component(s) may be disposed on, attached to, affixed to, integrated with, associated with, directly or indirectly connected to the device. The user interactive component may be wirelessly adapted to the device via a Bluetooth® or other connection. The user interactive component can provide outputs to a user or may provide an input from a user to the device, for example, the user interactive component may include buttons or toggles to receive an input from a user. Alternatively, the user interactive component may include a speaker into which a user can speak or provide an audio input. In one embodiment, the user interactive component may be coupled to a recording device such that the user can record sounds or audio on the interactive retaining device.

The term “condition” as used herein includes but is not limited to opening or closing of the retaining device, a motion of the retaining device, a change in circumstances of the surroundings of the retaining device such as but not limited to a temperature change of the surroundings of the device or of the device itself, a change in humidity of the surroundings of the device, a change in light exposure of the device. Condition may also include a contact with the device, or a sound in the surrounding area of the device. The surroundings of the device may include immediate surroundings between 0.1 inches to 12 inches from the device, or may include a larger surrounding area such as 1-3 feet or 3-6 feet from the device.

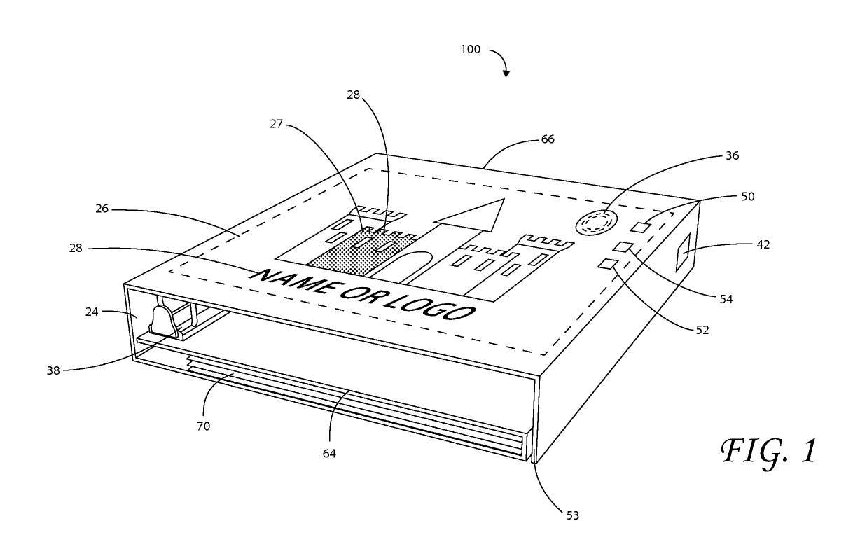

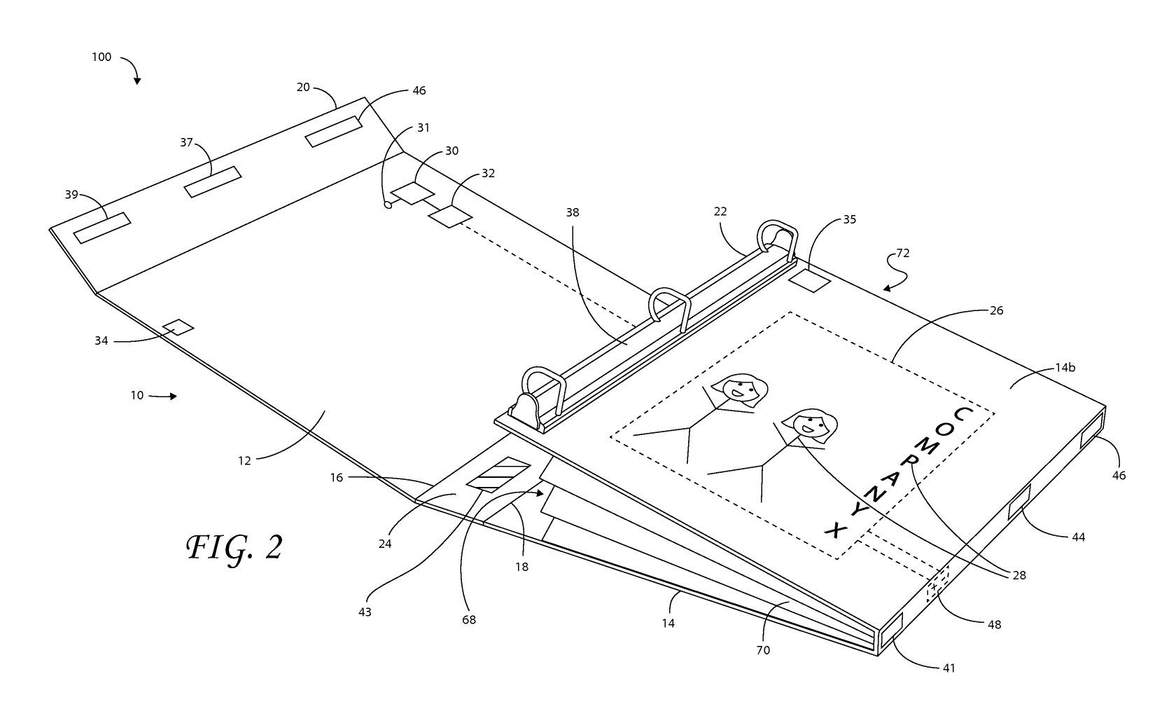

In one embodiment, as shown in FIGS. 1 and 2, a retaining device 100 including a body portion 10 including at least a first planar cover member 12 and a second planar cover member 14, each of said first and second planar cover members including an outer edge 20, 22 and an inner edge 16, 18. The first and second planar cover members 12, 14 are associated with one another at each respective inner edge 16, 18. In some embodiments, the retaining device includes a bridge member 24 disposed between the inner edges 16, 18 of the first and second planar cover members 12, 14. The retaining device further includes a user interactive component 26 associated with the body 10, wherein the user interactive component 26 provides an output to a user of the retaining device 100. The interactive component 26 may include at least one of a visual display component 28, a scent-emitting component 30 with or without a heating element 32, a gustatory component 34, and/or an audio component 36. The retaining member 100 may also include a binding mechanism 38 or a pocket 40 or a combination thereof associated with the body 10. The binding mechanism 38 or pocket 40 may be used to retain documents or other items for organization purposes or for transportation of such documents or items from one location to another.

The visual display component 28 may include a light emitting diode (LED) 27, and/or an electronic paper display device. The visual display component 28 may incorporate EPD (electronic paper display) technology to provide information to a user, or may include both EPD and LED such that the device can be used where the light conditions vary. EPD is useful in the daytime where plenty of light is available, however LED light is better suited for occasions where less light is available. The use of EPD and/or LED technology is discussed in US Patent Publication No. US 2011/0084952 A1 by YEN. The device 100 may be lit by any other means known in the art, and the visual display components 28 may be associated with any portion of the device so long as light provided by the lighting feature may be seen by a user of the device 100.

The visual display component 28 may be activated upon opening of the retaining device 100, or may be activated via a switch associated with the retaining device. Alternatively, there may be a touch sensor 42 associated with the device used to turn the visual display component 28 on or off. The retaining device 100 may further feature a magnetic contact switch 44 or contact sensor 46 such that when in a closed position, the visual display component 28 is off, and when in an open position, the visual display component 28 is on, or vice versa. The magnetic contact switch 44 may also be embodied as an attachment member 53 in an embodiment, wherein the attachment member 53 may be used to contact the first planar cover member 12 of the body 10 of the device 100 to the second planar cover member 14 of the retaining device 100, in other embodiments the attachment member 53 may be separate and distinct from the contact switch 44. The attachment member 53 may be in the form of a magnet, a Velcro® attachment, an adhesive attachment, a button and hole or loop attachment, a cord or string attachment, a Zipper® attachment, among other types of attachment members known to those of skill in the art. The retaining device 100 may include a battery, a switch, a processor, and LED/EPD. All of the components of the retaining device 100 may be electrically connected as necessary to provide an integrated system.

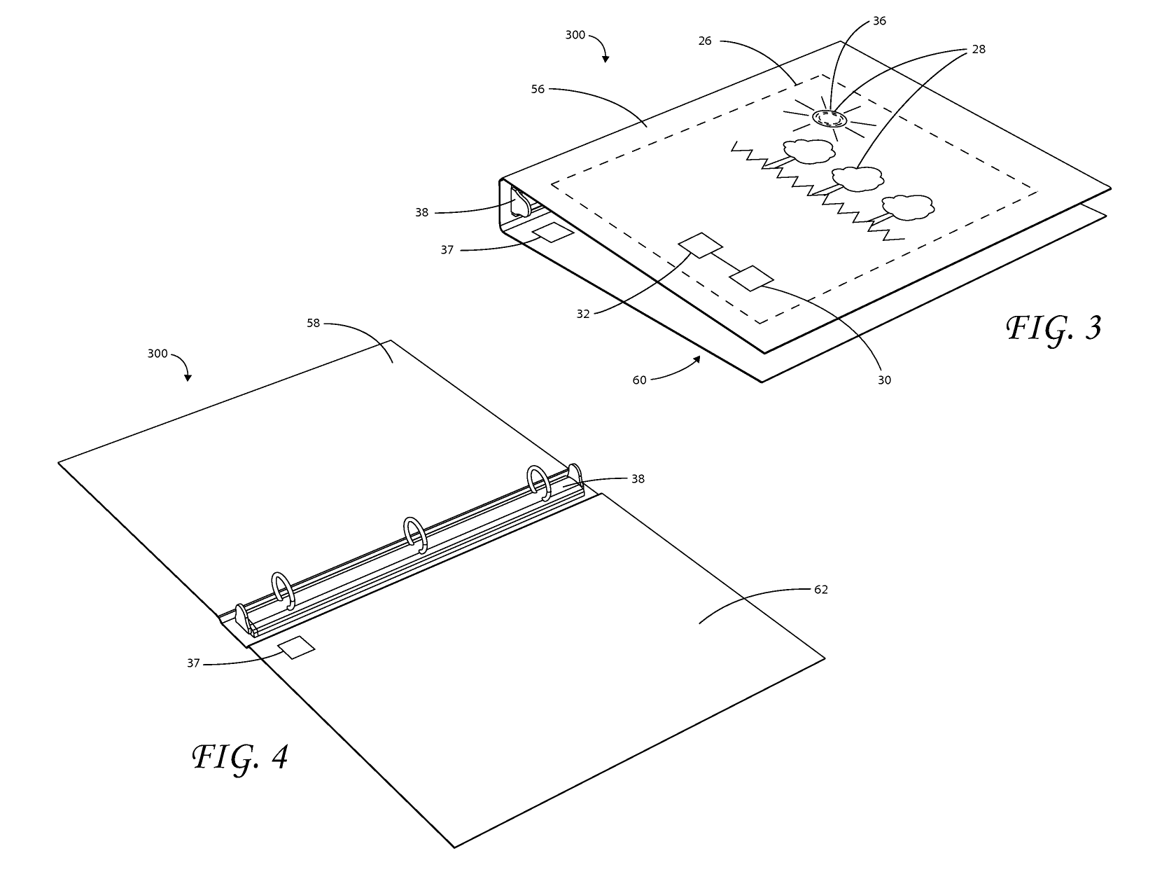

In another embodiment, shown for example in FIGS. 3 and 4, the user interactive component 26 of the retaining device 100 may include an audio component 36 whereby pre-recorded audio can be played, or an audio may be recorded on the audio component of the device by a user for later playback. For example, see US Patent Publication No. 2012/0011751 A1 (Schimke et al.). The audio component 36 may be coupled to the body 10 of the device 100 and may be configured for receiving audio information and playback. The audio component 36 may include a speaker, a connector capable of receiving audio information, a power source 48, and a first element 50 on or associated with the retaining device 100 for initiating an audio information playback. The audio information may be any pre-recorded message of the audio component 36 or may be input by the user of the device.

In another embodiment, the audio information received by the audio component 36 is automatically played when the device 100, is in the open position i.e., when the first and second planar cover members 12, 14 of the retaining device 100 are separated from one another, for example. Alternatively, or in addition, the audio information may be automatically played when the device 100 is in the closed position, i.e., when the first and second planar cover members 12, 14 of the retaining device 100 are in contact with one another. The retaining device 100 may further include a microphone 52 for receiving a recording from a user, and a second element 54 on or associated with the retaining device 100 for initiating a recording of audio information by the user.

In a further embodiment, the user interactive component 26 may include both an audio component 36 and a visual display component 28, wherein the audio and visual display components 36, 28 are configured to sequentially provide an output of a predetermined sequence to the user. The predetermined sequence may be based on the aforementioned multi-sensory learning advantages, wherein the various senses of the user are triggered synchronously or at predetermined sequential times with one another to enhance the learning experience of the device by taking advantage of the benefits of multi-sensory learning.

In another embodiment, the user interactive component 26 comprises a scent-emitting component 30. The scent-emitting component 30 can be used to attract the attention of a user of the retaining device 100. The scent-emitting component 30 can be provided on or within the retaining device 100, affixed to or positioned on one of the planar cover members of the device 12, 14. In cases in which the retaining device is multi-layered (containing multiple strata), at least one stratum of the device may be impregnated with a scent-emitting component, or the scent-emitting component 30 may be associated with the retaining device 100 by any other means know in the art. In a single-layered retaining device, the single layer may be impregnated with the scent-emitting component 30. The scent-emitting component 30 may be visible or non visible to a user of the device. The scent-emitting component 30 can be activated to dispense a fragrance to the user either upon opening or closing of the device 100, or upon contact with the device 100 or a predetermined portion of the device. Alternatively, the scent-emitting component 30 can dispense a fragrance in the area generally surrounding the retaining device 100 at a constant rate for a predetermined time period. The scent-emitting component 30 may dispense multiple fragrances.

There may be an activation switch 31 which controls the dispensing of the fragrance from the scent-emitting component 30. Other embodiments include a scent-emitting component 30 affixed to the innermost or outermost stratum of the retaining device 100, wherein a cover over the scent-emitting component 30 is affixed to the component 30 and wherein upon removal or opening of the cover, a fragrance from within the scent-emitting component 30 is released. The scent-emitting component may be embodied as in U.S. Pat. No. 4,802,626 issued to Forbes et al., or as in U.S. Pat. No. 6,643,967 issued to Bloom, for example.

The device may further include a heating element 32 coupled to the scent-emitting component 30, such that upon heating by the heating element 32, the scent-emitting component 30 gives off a fragrance to the user of the device 100. The heating element 32 is coupled to a power source 48 which may be disposed on the retaining device body 10 (embodied as an onboard battery, for example) or attached to one of the stratum thereon, for example. The heating element 32 and scent-emitting component 30 may be embodied as found in U.S. Pat. No. 4,339,079 issued to Sato et al., or as in U.S. Pat. No. 2,991,517 issued to Bundy et al., or as otherwise known in the art. Emission of the fragrance from the scent-emitting component 30 can occur upon activation of the heating member 32, upon opening or closing of the retaining device 100, by an operation switch, based on a pre-determined time release schedule, or the fragrance may be continuously released from the scent-emitting component 30.

In another embodiment, a retaining device 100 including a first planar cover member 12 and a second planar cover member 14 is provided. Each of said first and second planar cover members 12, 14 include an outer surface 56, 60, an inner surface 58, 62, a proximal edge, a distal edge, a first end edge 64 and a second end edge 66. A bridge member 24 including a planar bridge body portion having a bridge inner surface 24a, a bridge outer surface 24b, a first bridge outer edge 24c and a second bridge outer edge 24d, is provided wherein the first bridge outer edge associates with the first planar cover member inner edge 16 and the second bridge outer edge associates with the second planar member inner edge 18. The retaining device 100 further includes a binding mechanism 38 associated with the bridge inner surface 24a, the first planar cover member inner surface 58, or the second planar cover member inner surface 62. The binding mechanism 38 includes at least one binding member that moves from a released state to a binding state. The retaining device 100 further includes a visual display component associated 28 therewith. The visual display component 28 may include a light emission diode (LED) or an electronic paper display in some embodiments. The visual display component 28 may be disposed on or otherwise associated with the retaining device 100.

In a further embodiment of the retaining device 100, an expandable compartment 68 is associated with at least one of the first cover member 12 and the second cover member 14. The expandable compartment 68 including at least a first wall portion 70 and a second wall portion 72, the first and second wall portions 70, 72 spanning between a compartment outer cover 14b and the first cover member 12 and/or the second cover member 14, wherein the first and second wall portions 70, 72, or a combination thereof, comprise supernumerary material so as to allow expansion of the compartment outer cover 14b away from the first cover member 12 and/or the second cover member outer surface 14. The first or second wall portions 70, 72, or a combination thereof, may include a series of folds, in one embodiment. In another embodiment the expandable compartment 68 may include two or more separate slits into which material may be separately stored. In still a further embodiment, the retaining device 100 may include the scent-emitting component 30, gustatory component 34, heating element 32, at least first and second elements 50, 54 and audio components 36 as described with regard to the embodiments above.

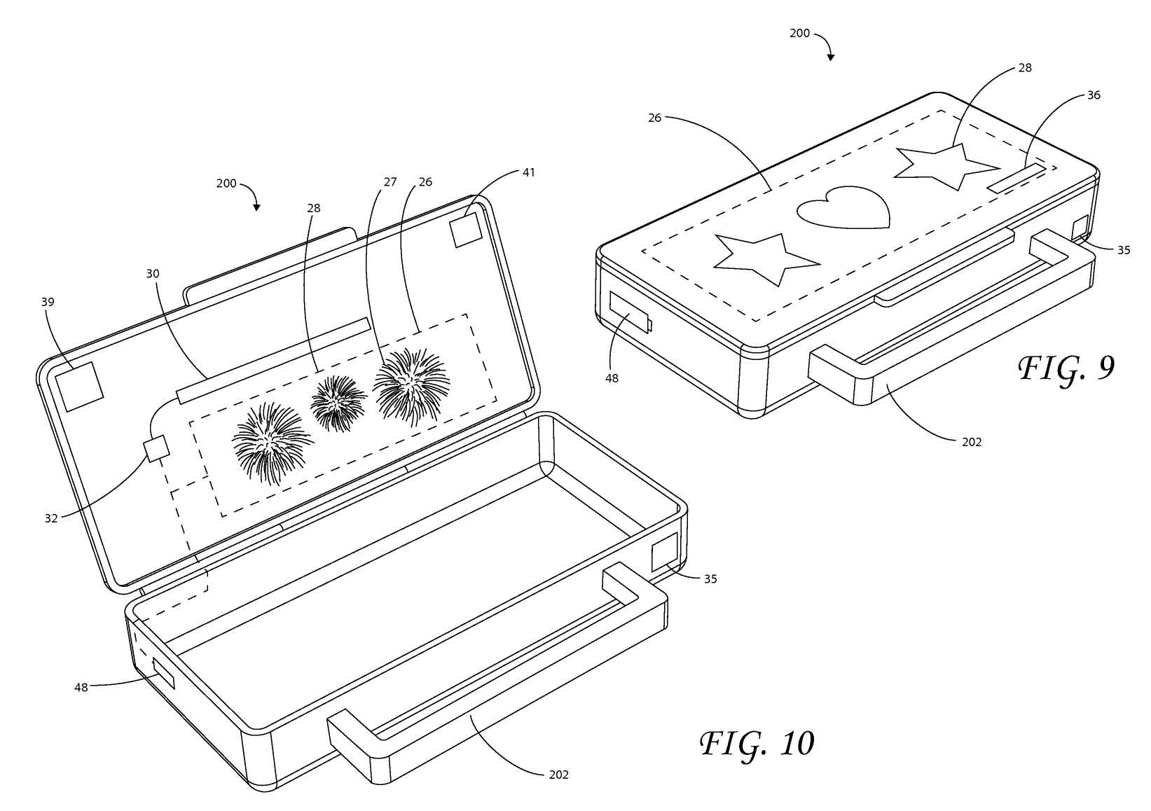

In a further embodiment, a container 200 (as shown for example in FIGS. 9 and 10, providing a view of the open and closed positions of the container 200) comprising a plurality of walls is provided. The walls are associated together to form an encasement and at least one of the plurality of walls is planar. At least one of the plurality of walls includes an interactive component 204, and the interactive component provides an output to a user of the container 200. The container may further include a handle 202 in one embodiment. The embodiments of FIGS. 3-4 provide a device 300 with a first planar cover member 12 and a second planar cover member 14. The user interactive component 26 with the audio component 36 and visual display components 28 are provided as well as the various sensors displayed.

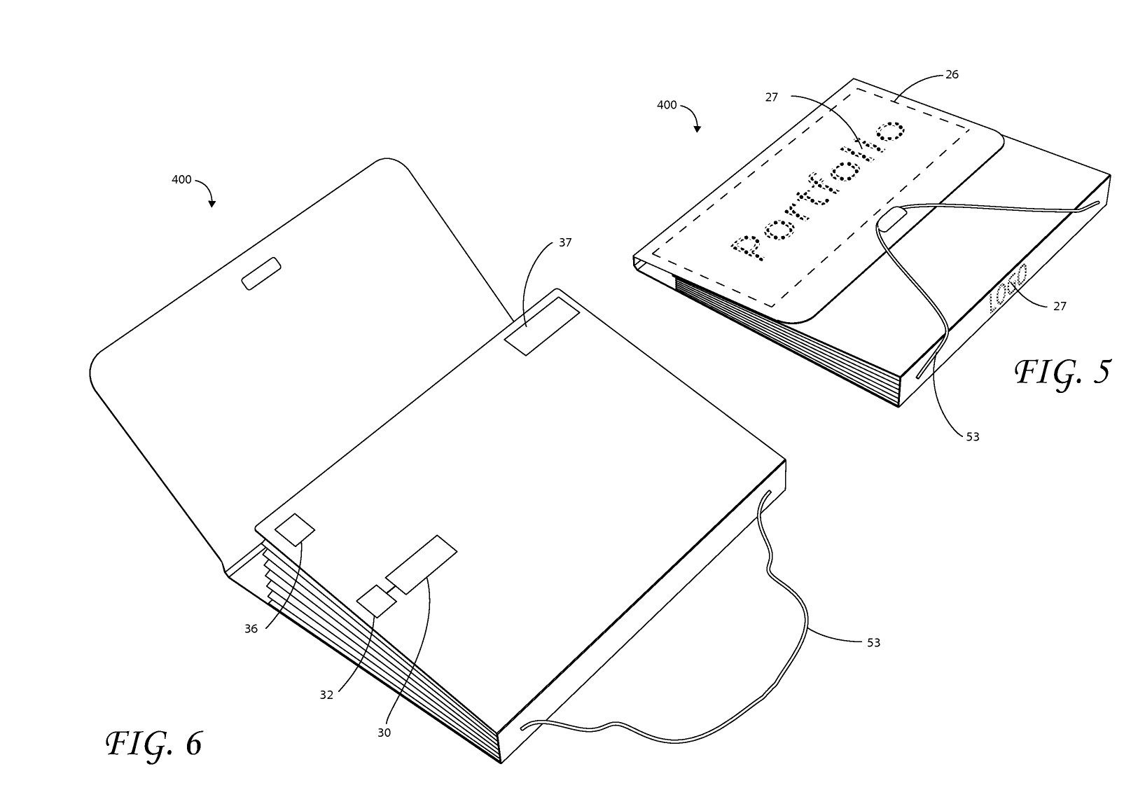

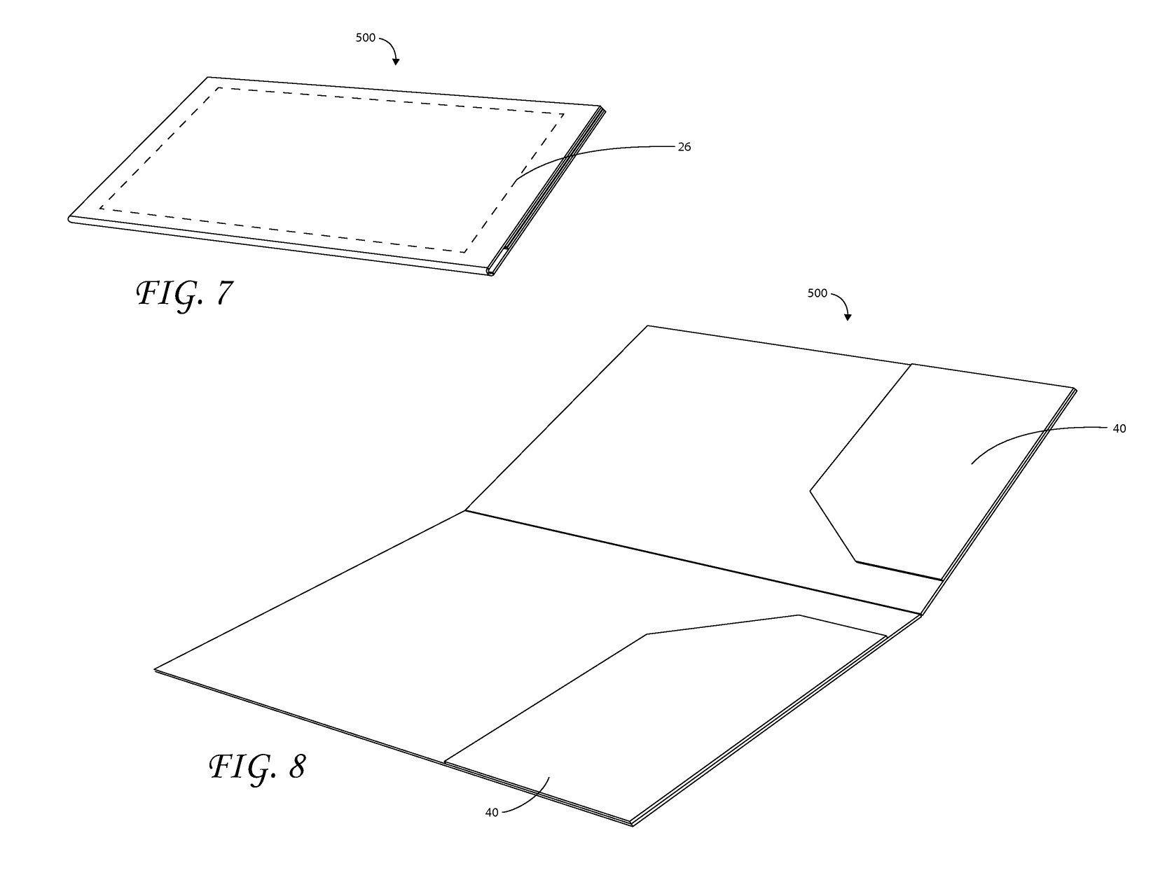

In a further embodiment, the interactive component 204 includes a visual display component 206, an audio component 208, a scent emitting component 210, or a heating element 212, or a combination thereof. In yet a further embodiment the visual display component includes at least one of an LED or an electronic paper display. The container 200 may further include a sensor 214 provided to sense a condition of the device as discussed herein. FIGS. 5-6 provide another embodiment of a device 400, shown in an open and closed position, with similar features as discussed above with regard to devices 100, 200, and 300, however, including some structural differences. FIGS. 7-8 include an embodiment of a device 500 similar to a folder, provided in an open and closed position, wherein a user interactive device 26 can be disposed thereon. This embodiment of the device 500 may also include all or some of the features included in the aforementioned embodiments, such as the visual component, the audio component, and various sensors, for example.

In some embodiments, an output of the device form the user interactive component is initiated in response to a predetermined value detected for a condition. In a further embodiment, the sensor is an orientation sensor 35, provided to detect an orientation of the device. In an embodiment an output of the user interactive component is initiated if the detected orientation meets a predetermined orientation. In yet another embodiment, the sensor is an audio sensor, configured to detect an audio value within 1-12 inches of the device. In another embodiment, an output of the user interactive component is initiated if the audio value meets a predetermined audio value. In yet another embodiment, the sensor is a light sensor 39, configured to detect an exposure to a light source. In another embodiment, an output of the user interactive component is initiated if exposure to a light source is detected. In still another embodiment, the sensor is a motion sensor 37, configured to detect movement of the retaining device or a portion thereof. In a further embodiment an output of the user interactive component is initiated if a movement of the retaining device or a portion thereof is detected. Any other types of sensors known in the art may be used in accordance with the retaining device and/or the container. Any of the sensors mentioned and disclosed herein can be associated with and/or disposed or attached to any of the embodiments discussed within this disclosure. Temperature sensors, moisture sensors, and any other types of sensors know to those of skill in the art are contemplated by the disclosure herein and may be used in place of or in addition to the sensors already described herein.

In another embodiment, a retaining device 100 comprising a first planar cover member 12 and a second planar cover member 14 is provided. Each of the first and second planar cover members 12, 14 include an outer surface 56, 60, an inner surface 58, 62, a proximal edge, a distal edge, a first end edge 64 and a second end edge 66. A bridge member 24 is provided including a planar bridge body portion having a bridge inner surface 24a, a bridge outer surface 24b, a first bridge outer edge 24c and a second bridge outer edge 24d, wherein the first bridge outer edge 24c associates with the first planar cover member inner edge 16 and the second bridge outer edge associates 24d with the second planar member inner edge 18. A binding mechanism 38 is associated with the bridge inner surface 24a, the first planar cover member inner surface 12a or the second planar cover member inner surface 14a, the binding mechanism 38 including at least one binding member that moves from a released state to a binding state. The retaining device 100 further includes a power source 48, a visual display component 28 configured to provide an output to a user of the device 100; and an audio component 36 configured to provide an output to the user of the device, wherein the power source 48 is in electrical communication with the visual display 28 and audio components 36, and wherein the visual display component 28 and the audio component 36 provide a predetermined sequence of outputs to the user.

In a further embodiment, the visual display component 28 and/or the audio components 36 are disposed on one or more surfaces of the device 100. In yet a further embodiment, the visual display 28 and audio components 36 and the power source 48 are electrically connected to one another via at least one conduit, and wherein the at least one conduit may connect between the first planar cover member 12, the second planar cover member 14 and/or the bridge member 24. The electrical conduit(s) are such that they may cross over a bend or crease formed in the device 100, for example, between two portions of the device 100, as between the first planar cover member 12 and the bridge member 24 in some embodiments. This provides advantages such as the ability to allow connections between multiple lighted portions of the device 100.

The details described herein in reference to device 100 may also apply to the embodiments 200, 300, 400, and 500, for example, the sensors, the output component and all related components thereof. It is clear that the device may take different forms or shapes, but that the various features described herein may be included in each one of the embodiments of the device.

It should be borne in mind that all patents, patent applications, patent publications, technical publications, scientific publications, and other references referenced herein are hereby incorporated by reference in this application in order to more fully describe the state of the art to which the present invention pertains.

It is important to an understanding of the present invention to note that all technical terms used herein, unless defined herein, are intended to have the same meaning as commonly understood by one of ordinary skill in the art. The techniques employed herein are also those that are known to one of ordinary skill in the art, unless stated otherwise.

While a number of embodiments of the present invention have been shown and described herein in the present context, such embodiments are provided by way of example only, and not of limitation. Numerous variations, changes and substitutions will occur to those of skill in the art without materially departing from the invention herein. For example, the present invention need not be limited to best mode disclosed herein, since other applications can equally benefit from the teachings of the present invention. Also, in the claims, means-plus-function and step-plus-function clauses are intended to cover the structures and acts, respectively, described herein as performing the recited function and not only structural equivalents or act equivalents, but also equivalent structures or equivalent acts, respectively. Accordingly, all such modifications are intended to be included within the scope of this invention as defined in the following claims, in accordance with relevant law as to their interpretation.

What is claimed is:

1. A retaining device, comprising:
a body comprising at least a first portion and a second portion, each of said first and second portions comprising an outer edge and an inner edge, said first and second portions associated with one another at each respective inner edge;
a binding mechanism or a pocket or a combination thereof associated with the body; and
a user interactive component associated with the body, wherein said user interactive component provides an output to a user of the retaining device.

2. The retaining device of claim 1, wherein said user interactive component comprises a visual display component.

3. The retaining device of claim 2, wherein said visual display component comprises at least one of a light emitting diode (LED) and an electronic paper display device.

4. The retaining device of claim 1, wherein said user interactive component comprises an audio component.

5. The retaining device of claim 1, wherein the user interactive component comprises an audio component and a visual display component, wherein the audio and visual display components are configured to sequentially provide an output of a predetermined sequence to the user.

6. The retaining device of claim 1, wherein said user interactive component comprises a scent emitting component.

7. The retaining device of claim 1, wherein said user interactive component comprises a heating element and a scent emitting component.

8. The retaining device of claim 1, further comprising a bridge member disposed between and in contact with the inner sides of the first and second portions of the device.

9. A retaining device comprising a first planar cover member and a second planar cover member, each said first and second planar cover member comprising an outer surface, an inner surface, a proximal edge, a distal edge, a first end edge and a second end edge;
a bridge member comprising a planar bridge body portion having a bridge inner surface, a bridge outer surface, a first bridge outer edge and a second bridge outer edge, wherein said first bridge outer edge associates with said first planar cover member proximal edge and said second bridge outer edge associates with said second planar member proximal edge;
a binding mechanism associated with the bridge inner surface, the first planar cover member inner surface or the second planar cover member inner surface, said binding mechanism comprising at least one binding member that moves from a released state to a binding state; and
a user interactive component associated with the retaining device.

10. The retaining device of claim 9, wherein said user interactive component comprises a visual display component.

11. The retaining device of claim 10, wherein said visual display component is disposed on the retaining device.

12. The retaining device of claim 10, wherein said visual display component comprises at least one of a light emission diode (LED) and an electronic paper display.

13. The retaining device of claim 1, further comprising a sensor to detect a condition of the device.

14. The retaining device of claim 13, wherein an output of the device from the user interactive component is initiated in response to a predetermined value detected for a condition.

15. The retaining device of claim 13, wherein the sensor is an orientation sensor, provided to detect an orientation of the device.

16. The retaining device of claim 15, wherein an output of the user interactive component is initiated if the detected orientation meets a predetermined orientation.

17. The retaining device of claim 13, wherein the sensor is an audio sensor, configured to detect an audio value within 1-12 inches of the device.

18. The retaining device of claim 17, wherein an output of the user interactive component is initiated if the audio value meets a predetermined audio value.

19. The retaining device of claim 13, wherein the sensor is a light sensor, configured to detect an exposure to a light source.

20. The retaining device of claim 19, wherein an output of the user interactive component is initiated if exposure to a light source is detected.

21. The retaining device of claim 13, wherein the sensor is a motion sensor, configured to detect movement of the retaining device or a portion thereof.

22. The retaining device of claim 21, wherein an output of the user interactive component is initiated if a movement of the retaining device or a portion thereof is detected.

23. The retaining device of claim 9 wherein an expandable compartment is associated with at least one of the first cover member and the second cover member, said expandable compartment comprising at least a first wall portion and a second wall portion, said first and second wall portions spanning between a compartment outer cover and said first cover member and/or said second cover member, wherein said first and second wall portions, or a combination thereof, comprise supernumerary material so as to allow expansion of said compartment outer cover away from said first cover member and/or said second cover member outer surface.

24-45. (canceled)
